(19) United States
(12) Patent Application Publication
(10) Pub. No.: US 2025/0096581 A1
(43) Pub. Date: Mar. 20, 2025

(54) BATTERY POWER SUPPLY ARCHITECTURE

(71) Applicant: SAFRAN ELECTRICAL & POWER, BLAGNAC CEDEX (FR)

(72) Inventors: Olivier DESHAYES, MOISSY-CRAMAYEL (FR); Sébastien THOMASSIER, MOISSY-CRAMAYEL (FR); Mathilde OUATTARA-BRIGAUDET, MOISSY-CRAMAYEL (FR)

(21) Appl. No.: 18/832,852

(22) PCT Filed: Feb. 14, 2023
(86) PCT No.: PCT/FR2023/050198

§ 371 Date: Jul. 24, 2024

(30) Foreign Application Priority Data
Feb. 16, 2022 (FR) FR2201370

(51) Int. Cl. H02J 7/00; B60L 58/19; B60L 58/21; H02J 1/06

(52) U.S. Cl. CPC H02J 7/0024; B60L 58/19; B60L 58/21; H02J 1/06; H02J 7/0031; B60L 2200/10; H02J 2310/44

(57) ABSTRACT

A battery power supply device of an electrical energy supply system for aircraft includes at least two battery modules connected to a DC power network through a positive line, a negative line, and power switching elements, wherein each module includes at least one switching device for isolating said module from said network or for connecting said module to the network.

### CROSS REFERENCE TO RELATED APPLICATIONS

This application is a US National phase Application of PCT/FR2023/050198 filed Feb. 14, 2023, which claims priority to French Patent Application No. 2201370 filed Feb. 16 2022, both of which are hereby incorporated in their entirety.

### TECHNICAL FIELD

This disclosure concerns the field of electrical generation and electrical energy distribution circuits for aircraft. These distribution circuits allow distributing electrical power from internal sources, for example generators or batteries, or from external sources, such as auxiliary power units or a ground power unit, to payloads or to other power distribution boxes of the aircraft and to protect said sources against short circuits in particular.

With the evolution of technologies in energy storage chemistry and with the increased use of electrical energy on board aircraft, batteries are assuming an increasingly important place in on-board electrical systems.

### BACKGROUND

It is known to use modules of lithium-ion (Li-Ion) batteries, comprising a plurality of Li-ion cells and grouped in battery packs associated with a management and protection device comprising circuit boards, switching elements, and fuses.

In terms of the architecture of a Li-ion battery module, power switching elements allow protecting and isolating the module.

In general, the architecture of Li-Ion battery systems is as described in FIG. 1.

Battery module 2 comprises cells 1. The choice of the arrangement of cells 1 in order to construct battery module 2 is dictated by the voltage level requirement (number of cells arranged in series, knowing that for a given chemistry the cell voltage is defined and known), and the power and energy requirements (number of cells arranged in parallel).

To implement these arrangements, a quantity of chains of cells in series S are placed in parallel P, or vice versa, to obtain the expected voltage and capacity in Amp-hours. Controllable power switching elements 3, 4 such as resettable circuit breakers in particular of the SSPC type, switches, or contactors allow connecting battery module 2 to the airplane direct current (DC) power network through a connector 7, while always-on connections to a charging device 5 and an always-on (“hot”) bus with one or more devices 6 to be powered on standby through a current limiter are present upstream of the power switching elements. A fuse 8 protects the line connecting a pole of the battery module to the aircraft DC power network.

In certain cases, these arrangements may be adjusted either statically, in which case the configuration is fixed, or in a matrix manner which, however, introduces complexity and a significant number of switching nodes, overdesigned for the actual requirements which do not need all possible combinations.

### SUMMARY

In view of the prior art, the present application proposes an architecture where the battery pack is broken up into several battery modules connectable in series or in parallel or even adaptably in series or in parallel as needed.

To achieve this, this disclosure proposes a battery power supply device of an electrical energy supply system for aircraft, comprising a battery pack provided with at least two battery modules connected to a DC power network through a positive line, a negative line, and power switching elements, wherein each module comprises at least one switching device adapted to isolate said module from said network or to connect said module to the network upstream of said power switches, the device comprising a control device for said switching devices, configured to control the switching of said switching devices in order to select the module(s) to be connected to the network or different configurations for connecting said modules to the network, the control device able to be configured to control the switching of the switching devices so as to balance the current supplied by the battery pack between the different configurations according to the power required in the different flight phases of the aircraft.

This allows having a modular power supply device. Furthermore, as the switching devices are not intended for switching power, they can be sized solely according to the current flowing through them and not according to the need to be able to cut off said current or to cut off a current such as a short-circuit current, and the selection may be changed throughout the flight of the aircraft. This also allows optimizing the sizing of the power cables of the aircraft's power network.

The features set forth in the following paragraphs correspond to embodiments that may be implemented independently of each other or in combination with each other:

The electrical power supply device may comprise, for each module, a plurality of switching devices for which said configurations comprise:
a series configuration in which at least two modules are connected in series to said positive line and negative line,
a parallel configuration in which said modules are connected in parallel to said positive line and negative line,
a configuration in which only one of said modules is connected to said positive line and negative line.
   This makes it possible to adapt the configuration to the demand for voltage or for current supply capacity.

The control device is advantageously adapted to control the switching of the switching devices to allow at least a selection of a maximum network voltage in the takeoff phase of the aircraft, an intermediate network voltage in the climbing phase of the aircraft, and a reduced network voltage in the cruising flight phase of the aircraft.

The control device is advantageously configured to control the switching of the power switching elements so as to cut off power before switching said switching devices to change the configuration, switch said switching devices at reduced or zero power, and restore the power once the switching devices have been switched to a new configuration.

This makes it possible to keep the switching devices small, as the current they are intended to cut off is zero or very low.

The switching device(s) are preferably relays of the semiconductor type or not.

### BRIEF DESCRIPTION OF DRAWINGS

Other features, details and advantages of the invention will become apparent upon reading the detailed description below of some non-limiting example embodiments, and upon analyzing the appended drawings, in which:

FIG. 1 shows a traditional battery architecture;

FIG. 2 shows a first embodiment of a battery architecture according to this disclosure;

FIG. 3 shows a second embodiment of a battery architecture according to this disclosure in a parallel configuration;

FIG. 4 shows the second embodiment of a battery architecture according to this disclosure in a series configuration;

FIG. 5 shows a third embodiment of a battery architecture according to this disclosure, comprising three battery modules;

FIG. 6 shows a table corresponding to the voltages/power of an architecture according to demand, with three or four modules.

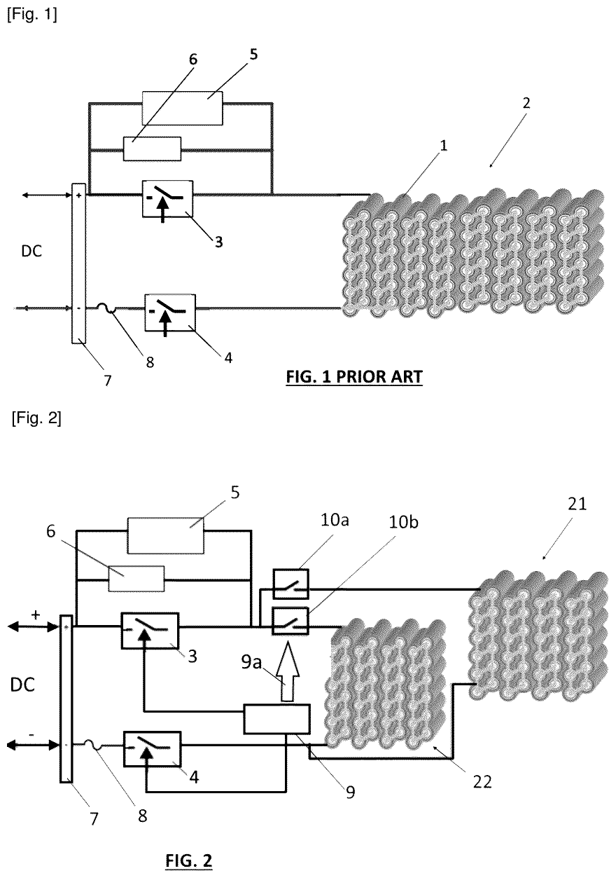

### DETAILED DESCRIPTION

The drawings and the description below contain elements which not only may serve to provide a better understanding of the invention, but also contribute to its definition, where appropriate.

This disclosure as shown in FIGS. 2 to 4 proposes an architecture where a battery pack is broken down into several battery modules 21, 22.

FIG. 2 shows a simplified embodiment in which two battery modules 21, 22 which constitute a battery pack are each provided with a switching device 10a, 10b upstream of power switching member 3 on a first line connected to a DC power network of the aircraft by a connection device 7. The DC network may have power sources other than battery pack 21, 22. A second power switching member 4 allows isolating the battery pack from the negative line of the DC network so that power switching elements 3 and 4 galvanically isolate the battery pack from the network in the event of a fault. These switching or cutoff devices must be able to provide protection and isolation in the event of a short circuit downstream of the battery pack, so as not to propagate the electrical fault to the aircraft wiring. They must therefore have a high interrupting capacity corresponding to the short-circuit current of the battery pack, typically a few hundred Amperes.

The power switching elements may in particular be of the SSPC type.

Battery modules 21, 22 are connected together or isolated via switching devices 10a, 10b which may be electromechanical relays of the semiconductor type or not, SSPC devices, or switches for example. These switching devices are arranged upstream of the power switches, i.e. on the module side as opposed to the DC network side in relation to the power switches. The switching devices have no capacity to interrupt short-circuit currents of the modules and they connect the modules under no load before the battery pack is connected to the DC network of the aircraft by closing the power switching elements 3, 4. The switching devices thus do not provide any protection of the pack against short circuits and therefore they can be relays of small dimensions and with an interrupting capacity just sufficient to cut the power supplied to hot bus 5, 6, a few amps for example.

In the embodiment of FIG. 2, battery modules 21, 22 may be used independently or connected in parallel for additional current.

The switching of the switching devices is managed by a control device 9 configured to control the switching of said switching devices according to the desired configuration: offline modules, single module, or parallel modules. Control device 9 comprises a bus 9a for controlling switching devices 10a, 10b.

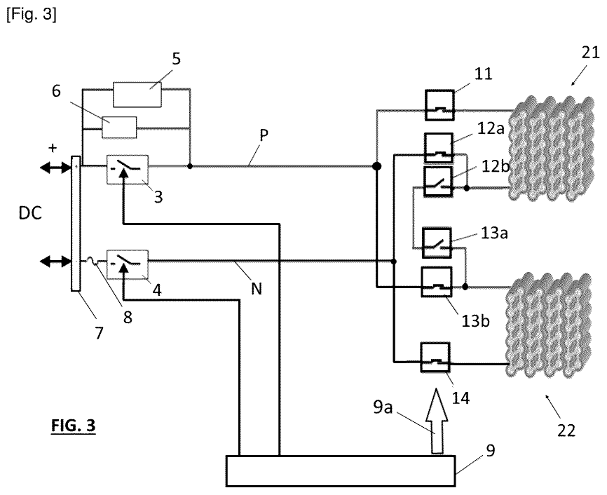

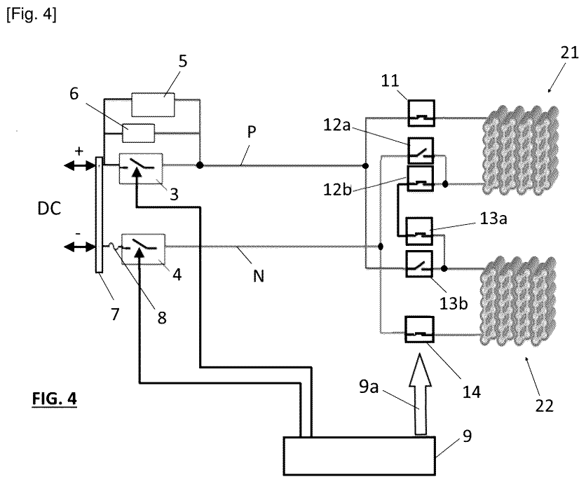

According to FIGS. 3 and 4, dual switching devices may be used to manage a change of configuration between having the modules in parallel or in series, which allows using each module 21, 22 alone, increasing the available power by placing modules 21, 22 in parallel in the case of FIG. 3, or increasing the output voltage of the battery pack by placing modules 21, 22 in series in the case of FIG. 4.

To do this, six switching devices 11, 12a, 12b, 13a, 13b 14 are used. Here, these switching devices are also controlled by a control device 9 through a control bus 9a.

First module 21 comprises a first switching device 11 on its positive pole, and a second switching device 12a and third switching device 12b on its negative pole.

First switching device 11 connects the positive pole of the first module to the positive line P connecting the battery modules to the network, or cuts off this connection.

Second switching device 12a connects the negative pole of first module 21 to the negative line connecting the battery modules to the network, or cuts off this connection.

Third switching device 12b connects the negative pole of first module 21 to the positive pole of second module 22 through fourth switching device 13a, or cuts off this connection (a single switch replacing switches 12b and 13a may also be used).

Second module 22 comprises a fourth switching device 13a and a fifth switching device 13b on its positive pole, and sixth switching device 14 on its negative pole.

Fourth switching device 13a connects the positive pole of second module 22 to the negative pole of first module 21 through third switching device 12b, as seen above.

Fifth switching device 13b connects the positive pole of the second module to the positive line P connecting the battery modules to the network, or cuts off this connection.

Sixth switching device 14 connects the negative pole of second module 22 to the negative line connecting the battery modules to the network, or cuts off this connection.

The described assembly with six switching devices allows transitioning from a single-module configuration where each module can be used separately to a configuration with modules in parallel or a configuration with modules in series.

In the configuration of FIG. 3 in which switching devices 11, 12a, 13b and 14 are closed while switching devices 12b, 13a are open, modules 21, 22 are placed in parallel in order to benefit from the full current capacity from all the battery modules.

In the configuration of FIG. 4, switching devices 11, 12b, 13a and 14 are closed to place the two modules 21 and 22 in series.

The series configuration has the advantage of making it possible to increase the available power in comparison to a single module, with no additional current and therefore without impacting the sizing of the wiring which can be calibrated to a module's nominal current in the case where the parallel configuration is not used.

By switching off switches 14, 13b and 13a, it is also possible to use only module 21; similarly, by switching off switches 11, 12a and 12b, it is possible to use only module 22.

The device as provided in FIGS. 3 and 4 thus allows:
transitioning from operating with a single module to operating with the two modules in series, which allows increasing the battery voltage to meet specific electrical power requirements such as starting up the engine or “boosting” electrical machines, while remaining compatible with the electrical system (cable gauges);
switching between a power supply device providing high capacity with modules arranged in parallel, to a power supply device providing high power with modules arranged in series, without increasing the current.

To keep the switching devices at reduced dimensions, the changes in configuration are made after cutting the power by means of power switching elements 3 and/or 4 which are sized according to the maximum power to be cut and according to the short-circuit current of the modules. This allows optimizing the design of the switching devices and reducing their mass and bulk since they are activated only when the current passing through them is zero or greatly reduced. To do this, control device 9 controls the power switches to isolate the modules and cut the power before switching the switching devices, then returns the modules to service and restores the supply of power after said switching.

The switching devices may be solid-state relay switches, such as SSPC modules for example.

In the case of the device of FIGS. 3 and 4, control device 9 is configured to control the switching of said switching devices between the various configurations: one module, two modules in series, two modules in parallel.

The principle described may be extended beyond the two modules presented above to a larger number of modules, which makes it possible to have a more refined modulation in the supply of power while maintaining a relatively stable current.

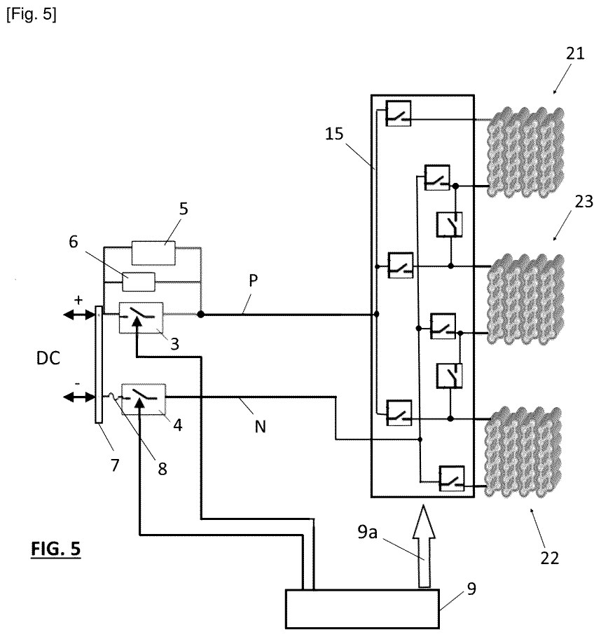

FIG. 5 shows a power supply device with three modules 21, 22, 23 and a switching module 15 provided with a plurality of switching devices. Here, these switching devices are also controlled by a control device 9 through a control bus 9a. The switching devices grouped in module 15 are wired so as to be able to connect the battery modules to the network either separately, or in series two by two, or all three in series or in parallel two by two, or all three in parallel.

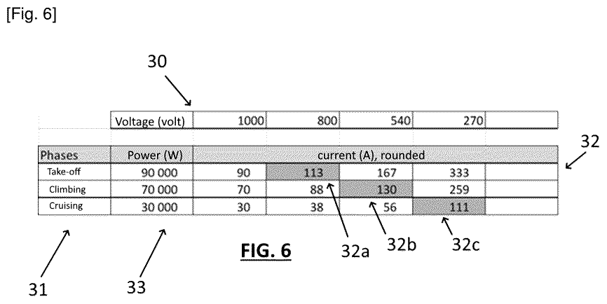

The table in FIG. 6 represents a table of voltage 30 on the abscissa/power 33 on the ordinate according to the flight phases 31, with the resulting currents rounded 32. This table shows that it is possible to smooth the current by organizing the modules in an arrangement of one module, box 32c; two modules in series, box 32b; and three modules in series, box 32c; while providing the power necessary for the flight phases of the aircraft: takeoff, climbing, and cruising. Thus, for an electrical system capable of handling a given current, the power supply device allows obtaining the significantly different power profiles necessary for the different flight phases. According to this example, in the case of takeoff, the power required for takeoff is 90 KW and the chosen voltage is 800 V. In the climbing phase the power is 70 KW, the chosen voltage is 540 V. In stabilized flight when cruising, the power is 30 kW and the chosen voltage is 270 V. For these powers and these voltages, the current rounded to the nearest unit is respectively 113 A, 130 A, and 111 A. According to this example, the current is therefore smoothed to around 100 A to 140 A for all power-consuming flight phases, which allows optimizing the mass of the wiring.

Similarly, a configuration, for example with four 250 V modules which allow obtaining a voltage of 1000 V in the take-off phase, allows further reducing the current required to 90 A for maximum delivered power, whereas for a voltage of 270 V, the current would be 333 A which would require very large cable cross-sections.

The device also has the advantage of being able to reduce the network voltage during stabilized flight at high altitude, which is favorable due to the fact that the breakdown voltage is reached more quickly with altitude, which means that, for example, a low voltage at altitude will be preferred.

Such a power/voltage adaptation also makes it possible to take full advantage of the gauges of power cables installed in aircraft and to not have to overdesign them, with the knowledge that the mass of large cables quickly becomes significant in the mass balance control of an aircraft such as an airplane.

Furthermore, the fact of having switching devices at the modules makes it possible to isolate a module detected as faulty, broken down, or out of order among n modules and to continue to use the energy stored in the n−1 modules, in reduced or degraded mode, to ensure the end of flight for example.

As said above, to keep the switching devices at low mass and bulk, operations to change configuration between single module, modules in series, and modules in parallel may be carried out after disconnecting the modules by means of the power switching elements, the modules being reconnected after the change in configuration.

Control device 9 is for example a computer provided for example with an FPGA or a processor equipped with non-volatile memory containing a program for controlling said switching elements and switching devices, volatile memory, digital outputs for controlling the switching elements and switching devices, and possibly provided with sensors and inputs for monitoring the state of the switching devices and switching elements.

The invention may be applied in particular to the electrical power systems of avionics systems or aircraft engine systems.

The invention is not limited to the examples described above solely by way of example, but encompasses all variants conceivable to those skilled in the art within the context of the protection sought.

1. Battery power supply device of an electrical energy supply system for aircraft, comprising a battery pack comprising at least two battery modules connected to a direct current (DC) power network through a positive line, a negative line, and power switching elements, and wherein each module comprises at least one switching device adapted to isolate said module from said network or to connect said module to the network, upstream of said power switches, characterized in that it comprises a control device for said switching devices, configured to control the switching of said switching devices in order to select the module(s) to be connected to the network or different configurations for connecting said modules to the network, said control device being configured to control the switching of the switching devices so as to balance the current supplied by the battery pack between the different configurations according to the power required in the different flight phases of the aircraft.

2. Battery power supply device according to claim 1, comprising, for each module, a plurality of switching devices for which said configurations comprise:
a series configuration in which at least two modules are connected in series to said positive line and negative line,
a parallel configuration in which said modules are connected in parallel to said positive line and negative line,
a configuration in which only one of said modules is connected to said positive line and negative line.

3. Battery power device according to claim 1, comprising at least three modules and wherein the control device is adapted to control the switching of the switching devices to allow at least a selection of a maximum network voltage in a take-off phase of the aircraft, an intermediate network voltage in a climbing phase of the aircraft, and a reduced network voltage in a cruising flight phase of the aircraft.

4. Battery power device according to claim 3, wherein said control device is configured to control the switching of the power switching elements so as to cut off power before switching said switching devices to change the configuration, switch said switching devices at reduced or zero power, and restore the power once the switching devices have been switched to a new configuration.

5. Battery power device according to claim 1, wherein the switching device(s) are relays of the semiconductor type.

6. Battery power device according to claim 1, wherein the switching device(s) are electromechanical relays.

7. Battery power supply device of an electrical energy supply system for aircraft, comprising a battery pack comprising at least two battery modules connected to a direct current (DC) power network through a positive line, a negative line, and power switching elements, and wherein each module comprises at least one switching device adapted to isolate said module from said network or to connect said module to the network, upstream of said power switches, comprising further a control device for said switching devices configured to control the switching of said switching devices in order to select the module to be connected to the network or different configurations for connecting said modules to the network, said control device being configured to control the switching of the switching devices so as to balance the current supplied by the battery pack between the different configurations according to the power required in the different flight phases of the aircraft and comprising, for each module, a plurality of switching devices for which said configurations comprise at least one of:
a series configuration in which at least two modules are connected in series to said positive line and negative line,
a parallel configuration in which said modules are connected in parallel to said positive line and negative line,
a configuration in which only one of said modules is connected to said positive line and negative line.

8. Battery power device according to claim 7, comprising at least three modules and wherein the control device is adapted to control the switching of the switching devices to allow at least a selection of a maximum network voltage in a take-off phase of the aircraft, an intermediate network voltage in the climbing phase of the aircraft, and a reduced network voltage in a cruising flight phase of the aircraft.

9. Battery power device according to claim 8, wherein said control device is configured to control the switching of the power switching elements so as to cut off power before switching said switching devices to change the configuration, switch said switching devices at reduced or zero power, and restore the power once the switching devices have been switched to a new configuration.

10. Battery power device according to claim 7, wherein the switching device(s) are relays of the semiconductor type.

11. Battery power device according to claim 7, wherein the switching device(s) are electromechanical relays.
